(19) United States
(12) Patent Application Publication
(10) Pub. No.: US 2006/0031309 A1
(43) Pub. Date: Feb. 9, 2006

(54) Electronic mail attachment management system and method

(75) Inventors: Vincenzo Valentino Di Luoffo, Sandy Hook, CT (US); Craig William Fellenstein, Brookfield, CT (US); Rick Allen Hamilton, Charlottesville, VA (US); Timothy Moffett Waters, Hiram, GA (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/850,403

(22) Filed: May 20, 2004

(51) Int. Cl. G06F 15/16

(52) U.S. Cl. 709/206

(57) ABSTRACT

The present invention provides a method for email attachment management. An email is received. The email is scanned to detect an attachment. If the email contains an attachment, the attachment is detached from the email. The detached attachment is stored in a storage location on a storage medium. The email is modified to include a link, the link at least identifying the storage location and the modified email is stored.

### TECHNICAL FIELD

The present invention relates generally to the field of communications and, more particularly, to an electronic mail attachment management system and method.

### BACKGROUND

In the business world, communication often plays a key role in completing objectives on schedule. Modern communication systems often provide electronic mail, or “email,” services and protocols to allow users to transmit and receive messages electronically. Modern email services often provide the capacity to support attachments. Generally, attachments are, for example, electronic versions of documents, electronic versions of images, and other data that can be represented electronically. Attachments are often substantially larger than the email with which they are associated. Moreover, the amount of data exchanged and managed in email systems often grows faster than the storage and processing capacity of current storage mechanisms, techniques, methods, and machine utilization strategies.

Thus, Internet service providers, business corporations, and other organizations that offer email services, often apply control mechanisms for the amount of data being stored by individuals. Some of these traditional control mechanisms include deleting attachments after a certain number of days, allowing users to setup local data stores for later insertion of new inbound emails into the stores based on keyword recognition, and/or other control mechanisms. Other control mechanisms are applied manually, requiring the owner of the email to self-manage their data storage and repository size, a task that is very time consuming, impedes end-user productivity, and adds to the compounding data storage problem.

Moreover, textual emails with large attachments abound in the current messaging infrastructure. These large attachments can take up the majority of storage space in storage devices attached to email servers. Therefore, where possible, email system administrators often put quotas on individual email accounts to limit the amount of usage and consequently control the costs associated with storage. However, these quotas add an extra level of administration to the already taxed email administrator. Some current systems allow a user to copy these large email attachments. However, the email itself still contains the attachment, and the end user has essentially duplicated the attachment to their workstation or laptop computer, without reducing the storage demand on the email server. In some current systems, the user can delete the email to preserve storage space on the email server and to meet the email database quota. However, the email itself can contain critical information or other information the user does not want to lose such as, for example, passwords, contact information, and other information.

Therefore, there is a need for a method and/or apparatus for managing electronic mail attachments that addresses at least some of the problems associated with conventional methods and apparatuses.

### SUMMARY

The present invention provides a method for email attachment management. An email is received. The email is scanned to detect an attachment. If the email contains an attachment, the attachment is detached from the email. The detached attachment is stored in a storage location on a storage medium. The email is modified to include a link, the link at least identifying the storage location and the modified email is stored.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a communication system; and

FIG. 2 is a flow diagram depicting an electronic mail attachment management method.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or in some combinations thereof. In a preferred embodiment, however, the functions are performed by a processor such as a computer or an electronic data processor in accordance with code such as computer program code, software, and/or integrated circuits that are coded to perform such functions, unless indicated otherwise.

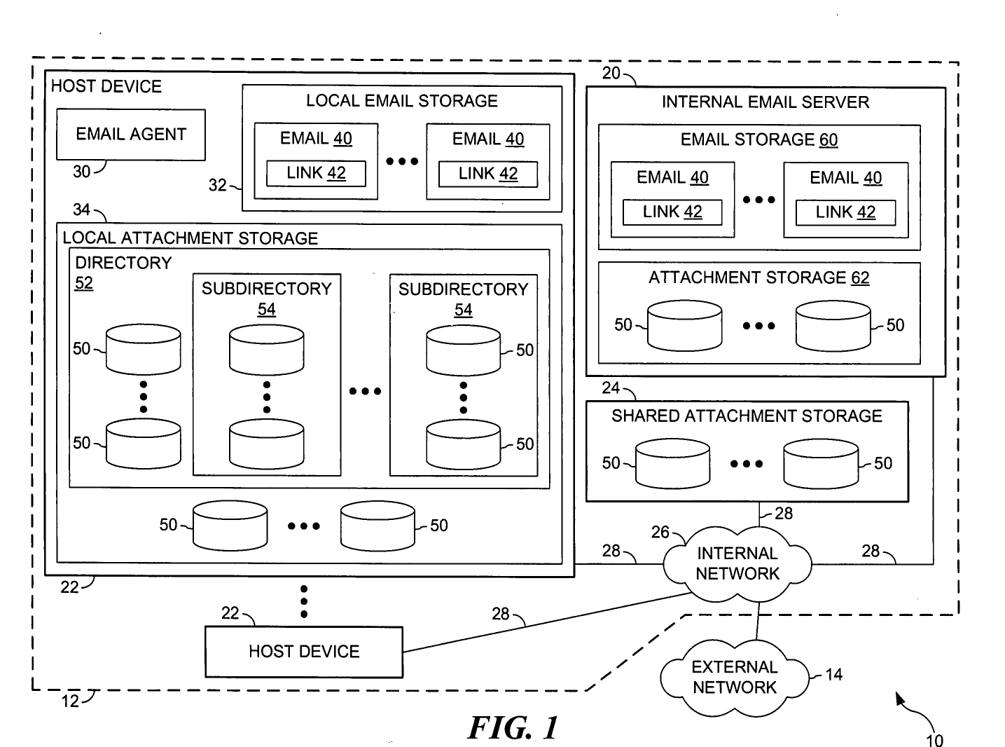

Referring to FIG. 1 of the drawings, reference numeral 10 generally designates a communication system. Communication system 10 includes an internal system 12 coupled to an external network 14. External network 14 is any computer and/or communication network including, but not limited to the Internet, intranets, the Public Switched Telephone Network (PSTN), local area networks (LANs), wide area networks (WANs), or metropolitan area networks (MANs). Internal system 12 includes internal email server 20, one or more of a plurality of host devices 22, shared attachment storage 24, and internal network 26. Internal email server 20, host devices 22, and shared attachment storage are coupled to internal network 26 through communication channels 28. Communication channels 28 are wireless links, wire line links, satellite links, Internet connections, infrared links, network links, or other suitable connections. Internal network 26 is any computer and/or communication network including, but not limited to the Internet, intranets, the Public Switched Telephone Network (PSTN), local area networks (LANs), wide area networks (WANs), or metropolitan area networks (MANs).

Internal email server 20 is an email server or any device suitable to be configured to operate an electronic mail (email) service and protocol. Generally, an email service sends and receives email to and from one or more networks or devices, based on one or more protocols. Generally, a server is a processor, such as a computer or other device, operating on a network, and manages network resources. In some systems, such as multiprocessor operating systems, for example, a server can be a computer performing tasks in accordance with a plurality of computer program codes, or “programs,” at once, and a program that manages certain resources is the server for those resources. Accordingly, in some systems, a single computer can include more than one server, such as, for example, a file server, a database server, and an email server. An email server is a server configured to manage or operate an email service, such as, for example, sendmail, Exim, DMail Email Server, Eudora Internet Mail Server, MDaemon, MailMax, Microsoft Exchange, Nu-Mail, Qmail Mail Server, and VOPmail.

Generally, an email server can include a mail transfer agent (MTA) and a delivery agent. A mail transfer agent (MTA) is a device or software that transfers email between network devices or to another transfer agent and routes email from the source to the destination, such as, for example, smail, Multi-channel Memorandum Distribution Facility (MMDF), and NTMail. A delivery agent is a device or software that stores an incoming email in a specific file or destination based on the designated recipient specified in the email, such as, for example, procmail, mail.local(lm), and deliver. A delivery agent is also configured to interact with a user's mail user agent (MUA), as described in more detail below. Email transfers are generally governed by one or more protocols, such as, for example, Simple Mail Transfer Protocol (SMTP), Extended SMTP (ESMTP), Unix-to-Unix Copy Protocol (UUCP), X.400, Post Office Protocol 3 (POP3), and Internet Message Access Protocol (IMAP). In many email services, SMTP is employed to manage outgoing email and POP3 and/or IMAP is employed to manage incoming email.

Internal email server 20 can be a dedicated email server, a general network server that also functions as the email server, a multi-switch email server for commercial routing, an entirely internal server, permitting only email to and from destinations within internal system 12, a combination of one or more of the foregoing servers, or other suitable email server. In particular, internal email server 20 is configured to receive email and associated attachments, if any, through internal network 26 from external network 14, to store received email and associated attachments, to transmit stored email and associated attachments to a host device 22 through internal network 26, to receive modified email from host devices 22 through internal network 26, to store modified email, to receive outgoing email and associated attachments, if any, from host devices 22 through internal network 26, and to transmit outgoing email and associated attachments, if any, to network 14 through internal network 26.

Internal email server 20 includes email storage 60 and attachment storage 62. Email storage 60 is a storage device, such as, for example, a database, hard drive, tape drive, optical drive, or other suitable storage media and is configured to store and organize email. Attachment storage 62 is a storage device, such as, for example, a database, hard drive, tape drive, optical drive, or other suitable storage media and is configured to store and organize email attachments. For illustrative purposes, email storage 60 is depicted as including a plurality of emails 40 with embedded links 42, and attachment storage 62 is depicted as including a plurality of email attachments 50. As described in more detail below, email storage 60 is also configured to store and organize email and any associated email attachments. In the illustrated embodiment, internal email server 20 is depicted with a single email storage 60 and attachment storage 62. In an alternate embodiment, internal email server 20 can be configured with an email storage 60 and/or attachment storage 62 for each host device 22, for each user account, for a group of host devices 22 and/or user accounts, or otherwise suitably configured.

Internal system 12 also includes one or more of a plurality of host devices 22. In the illustrated embodiment, host devices 22 are coupled to internal email server 20 through internal network 26. In an alternate embodiment, host devices 22 are coupled directly to internal email server 20. It will be understood to one skilled in the art that other configurations can also be employed.

Host devices 22 are any devices or software suitable to be configured to operate a mail user agent (MUA) including, but not limited to desktop computers, laptop computers, mobile telephones, or other suitable devices. A mail user agent (MUA) is a device or software configured to send and receive email, such as, for example, elm, mailx, zmail, Netscape, mh, metamail, Evolution, Mozilla Mail, Outlook Express, Eudora, and Pegasus. In particular, each host device 22 includes email agent 30, local email storage 32, and local attachment storage 34. As used herein, “each” means all of a particular subset. In the illustrated embodiment, email agent 30, local email storage 32, and local attachment storage 34 are depicted as separate, discrete components of host device 22. In alternative embodiments, email agent 30, local email storage 32, and local attachment storage 34 can be combined into a single device or module, one or more separate devices or modules, or otherwise suitably combined.

Email agent 30 is a mail user agent configured to receive email and associated attachments, if any, from internal email server 20 through internal network 26, to store received email and associated attachments, to generate and store outgoing email and associated attachments, if any, to transmit outgoing email and associated attachments, if any, to internal email server 20 through internal network 26, to generate and store modified email and associated attachments based on received email and associated attachments, and to transmit modified email to internal email server 20 through internal network 26. Email agent 30 is also configured to receive user policies and other input from a user and to generate and store modified email and associated attachments based on received user policies. In particular, as described in more detail below, email agent 30 is configured to receive an email with an associated attachment, remove the associated attachment, store the associated attachment in a particular location in local attachment storage 34, and modify the received email by embedding a link pointing to the particular storage location, based on received user policies. In one embodiment, email agent 30 is configured to interact with a user through a graphical user interface (GUI).

Local email storage 32 is a storage device, such as, for example, a database, hard drive, tape drive, optical drive, or other suitable storage media and is configured to store and organize email. As described in more detail below, local email storage 32 is also configured to store and organize email and any associated email attachments. Local attachment storage 34 is a storage device, such as, for example, a database, hard drive, tape drive, optical drive, or other suitable storage media and is configured to store and organize email attachments. As illustrated, local attachment storage 34 includes a plurality of email attachments 50 and a directory 52, and directory 52 includes a plurality of email attachments 50 and one or more subdirectories 54. For illustrative purposes, local email storage 0.32 is depicted as including a plurality of emails 40 with embedded links 42, and local attachment storage 34 is depicted as including a plurality of email attachments 50 and a directory 52 with subdirectories 54. It will be understood to one skilled in the art that local email storage 32 can also be configured to include a directory 52, with or without subdirectories 54, or otherwise configured to organize stored email in one or more directories and/or subdirectories. For example, local email storage 32 can be configured to include an inbox and an outbox, where an inbox is a file, or a directory of files where received email is stored, and can be represented through a GUI, and where an outbox is a file, or a directory of files where is email is stored for transmission, and can be represented through a GUI. In one embodiment, each email is stored in a separate file. In an alternate embodiment, a group of emails are stored in a single file, with new email appended to the file. It will be understood to one skilled in the art that local email storage 32 and local attachment storage 34 can also be configured to organize stored email or attachments in one or more directories and/or subdirectories in a wide variety of configurations.

Internal system 12 also includes shared attachment storage 24. Shared attachment storage 24 is a storage device, such as, for example, a database, hard drive, tape drive, optical drive, or other suitable storage media and is configured to store and organize email attachments. As illustrated, shared attachment storage 24 includes a plurality of email attachments 50. It will be understood to one skilled in the art that shared attachment storage 24 can also be configured to organize stored email or attachments in one or more directories and/or subdirectories in a wide variety of configurations.

Generally, in operation, internal network 26 receives an email and associated attachments, if any, and passes the received email and associated attachments, if any, to internal email server 20. Internal email server 20 stores the received email and associated attachments, if any, in email storage 60. Internal email server 20 also passes a copy of the received email and associated attachments, if any, to one or more host devices 22, based on the recipient designated in the email. Email agent 30 of host device 22 receives the email and associated attachments, if any, from internal email server 20, detaches, or removes, any associated attachments from the received email, stores the detached attachments in local attachment storage 34, modifies the received email by embedding in or appending to the email a link or other pointer, indicating where the detached attachment or attachments are located in local attachment storage 34, and saves a copy of the modified email in local email storage 32. Email agent 30 also sends a copy of the modified email to internal email server 20. Internal email server 20 replaces the original received email and associated attachments, if any, with the modified email received from email agent 30. Thus, the storage burden of storing email attachments is shifted from internal email server 20 to host device 22 and information in the email is preserved. For example, a 24 kb email that has a 10 MB size attachment would be stripped of the attachment upon replication to the user's local email client and the modified email sent back to the server. Thus, the server copy would be only 24 kb in size, instead of 24 kb+10 MB, and a drastic storage reduction is realized. Moreover, especially where email agent 30 is configured to remove attachments automatically, the user would not have to perform self-administration of their email databases, thereby greatly improving end-user productivity.

Generally, “detaching an attachment” and “removing an attachment” are used herein interchangeably. In one embodiment, email content is restricted to text information and attachments are converted from their original format to a text format and appended to the email. Thus, in one embodiment, removing an attachment includes deleting the text format version of the attachment appended to the email and converting the text format version of the attachment back to the original version for storage. It will be understood to one skilled in the art that other suitable configurations for associating an attachment with an email can also be employed, and detaching an attachment implies compatibility with the particular configuration employed.

In the illustrated embodiment, email agent 30 detaches and stores attachments automatically, as email is received. Thus, email agent 30 can be configured to receive an incoming email, scan the incoming email for attachments, detach any attachments, store the detached attachments in a user-configurable directory (local attachment storage 34), embed a link to the attachment in the email, and store the modified email in the user's inbox. Email agent 30 can also be configured to store attachments in shared attachment storage 24, another host device 22, another storage location or device on a grid, or other suitable storage location. Thus, email agent 30 is a configurable, programmatic, autonomic, email agent.

Email agent 30 can also be configured to store incoming email and attachments in local email storage 32 and periodically scan received emails for attachments, detaching and storing the attachments and modifying the email as appropriate. Email agent 30 can also be configured to store incoming email and attachments in local email storage 32 and scan received emails for attachments when requested by the user. Thus, where automatically scanning and detaching attachments slows receipt of email, for example, a user can retrieve email with attachments and manage the attachments at a more convenient time. Accordingly, local email storage 32 can be configured to store both modified email and email with attachments. In an alternative embodiment, local email storage 32 is configured to store only modified email and email without attachments. Such an embodiment can be employed where, for example, the system email administrator wants to force users to manage their received attachments as they are received. Accordingly, email agent 30 can also be configured to manage attachments as they are received, without storing email with attachments for later handling.

Email agent 30 can also be configured to perform velocity checking, where email agent 30 queries a user each time an email with an associated attachment is received and, based on the user input, can detach and delete the attachment, open the attachment in a default or user-specified program, detach and store the attachment in a default or user-specified storage location and modify the email to include a link identifying the storage location, store the email and associated attachment in local email storage 32, or perform other suitable functions based on the user input.

Email agent 30 can also be configured to operate automatically, and query a user only when attachment storage meets a predetermined threshold, such as, for example, “data store 103 met 225M threshold, transfer to location XYZ?” Thus, email agent 30 can be configured to detach only attachments meeting a certain storage size threshold or other characteristics. Email agent 30 can also be configured to automatically detach and store attachments, alerting a user that the attachment has been removed. Email agent 30 can also be configured to search for stored attachments in a variety of storage locations and report the location of the stored attachments, retrieve the stored attachments, and/or delete the stored attachments.

As described above, email agent 30 is configured to modify email to include a link identifying the storage location of a removed attachment, such as, for example, link 42. Link 42 can be configured in a variety of ways, including, for example, a text reference identifying the attachment and its storage location, a hyperlink or button configured to load the attachment in a default or user-specified program, a hyperlink or button configured to allow options such as, for example, deleting the attachment, moving the attachment to a different storage location, opening the attachment, or other options, or otherwise suitably configured. Link 42 can also be configured to include information about the attachment, such as, for example, the name of the attachment, the time and/or date the attachment was created and/or last modified, the author of the attachment, the type of attachment, and/or other information, if available. Moreover, email agent 30 can also be configured to automatically update link 42 if the attachment is moved to a different storage location or deleted, and/or to allow user input to manually modify link 42 when, for example, the user manually moves the attachment to a different storage location. It will be understood to one skilled in the art that other configurations can also be employed.

As described above, email agent 30 can also be configured to receive user policies from a user to govern the operation of email agent 30. User policies can include user preferences or rules for how often email agent 30 scans received email for attachments, where attachments and/or email are to be stored, notification preferences, link format preferences, thresholds for detaching attachments and other suitable preferences or rules. For example, user policies can specify a default general attachment directory (in local attachment storage 52), a “from-specific” attachment directory (in local attachment storage 52) where attachments from certain users are stored, a content-specific attachment directory (in local attachment storage 52) where attachments with certain characteristics, such as, for example, spreadsheets, are stored, and/or storage locations paralleling the local destinations on remote devices or machines, such as, for example, shared attachment storage 24. Moreover, email agent 30 can be configured to store removed attachments in a particular storage location based on user policies and/or an algorithm using certain email characteristics, such as, for example, the originating sender, an access control list, whether the email originates outside internal system 12, or other suitable characteristics.

In the illustrated embodiment, attachment management, that is, removing and storing attachments and modifying the original email, is performed by each host device 22, in particular, email agent 30. In an alternate embodiment, internal email server 20 is configured to remove attachments from email, store the removed attachments, modify the email to include a link, and store the modified email. Internal email server 20 can be configured to store the attachment in attachment storage 62, shared attachment storage 24, or other suitable storage location. Additionally, internal email server 20 can be configured to delete a stored attachment when the attachment is stored in a local attachment storage 34. Moreover, internal email server 20 can be configured to detach and store an attachment in attachment storage 62 upon receipt of a modified email from host device 22 and storing the modified email in email storage 60. Where an email is addressed to more than one user, internal email server 20 can be configured to store the associated attachment in attachment storage 62 and delete the attachment once all recipients have returned a modified email based on the original email and attachment. Internal email server 20 can also be configured to retain the original email and attachment in email storage 60 until all recipients have return a modified email based on the original email and attachment. It will be understood to one skilled in the art that other configurations can also be employed.

As illustrated, the operation of internal system 12 is described with respect to email and attachments generally, without adding detail to describe the characteristics of a particular email or attachment. It will be understood to one skilled in the art that internal email server 20, host device 22, shared attachment storage 24, and internal network 26 can also be configured to transmit and/or receive other suitable information and/or data, such as, for example, date and time information, clock synchronization information, security information, encryption information, digital signatures, or other suitable information and/or data.

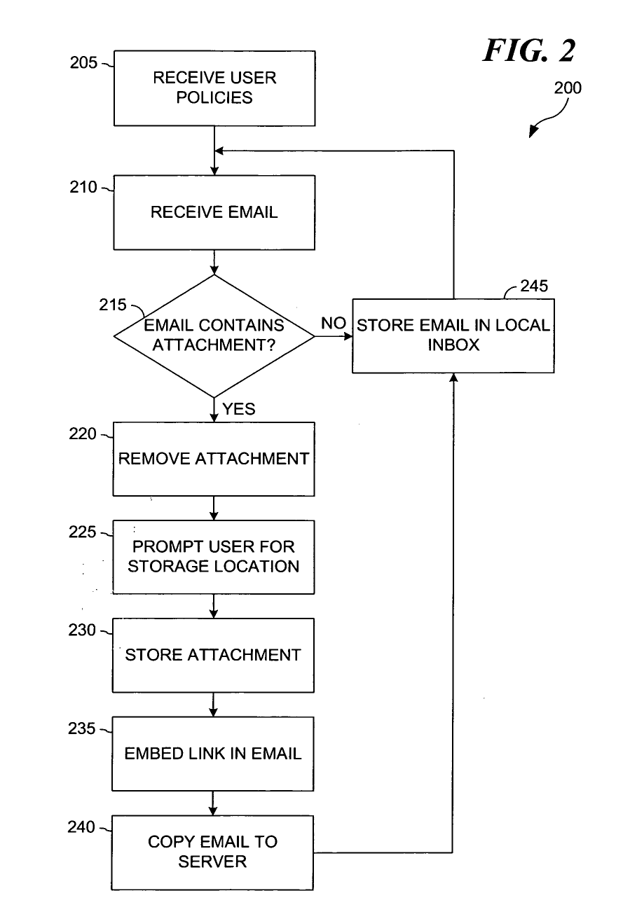

Referring now to FIG. 2 of the drawings, the reference numeral 200 generally designates a flow chart depicting a method for electronic mail attachment management. Generally, the steps of the method described in FIG. 2 are performed by email agent 30 of host device 22 of FIG. 1. It will be understood to one skilled in the art that internal email server 20 and/or other components of host device 22 can also perform one or more of the steps of the method described in FIG. 2, as appropriate, as described above.

The process begins at step 205, wherein user policies are received. As described above, user policies can include general default user preferences and/or rules describing, for example, when to scan email for attachments, when to notify the user that an attachment has been stored, whether to query the user each time an attachment is detected, where to store removed attachments, what options to include in the link, and other suitable preferences and/or rules. It will be understood to one skilled in the art that this step can be performed once, such as, for example, when email agent 30 of FIG. 1 is first installed, and/or multiple times whenever the user elects to modify existing policies or establish new policies.

At next step 210, email is received. At decisional step 215 a determination is made whether the received email contains an attachment. If at decisional step 215 the email received in step 210 does not contain an attachment, the process continues along the NO branch to step 245. At step 245, the email received in step 210 is stored and the process returns to step 210. As depicted, the received email is stored in the user's local inbox. It will be understood to one skilled in the art that other storage locations and/or options can also be employed, particularly in accordance with the user policies received in step 205. Moreover, it will be understood to one skilled in the art that receiving email is not generally a continuous process, as email is often sent, and therefore received, sporadically. Therefore, a period of time can elapse between the time step 245 is performed and a next email is received (step 210).

If at decisional step 215 the email received in step 210 contains an attachment, the process continues along the YES branch to step 220. At step 220, the attachment is removed from the email. At next step 225, a user is prompted for a storage location for the attachment and user input is received. As described above, this step can include presenting a default storage location for the attachment and/or options to the user, such as, for example, an option to open the attachment, delete the attachment, store the attachment in a user-specified storage location, or other options. Moreover, in one embodiment, the user can specify user policies to skip step 225 and proceed in accordance with default policies. Additionally, in one embodiment, the user can specify user policies to perform step 225 before step 220 and to prompt the user whether to remove the attachment and/or specifying other options.

At next step 230, the attachment is stored in a storage location specified by the user policies received in step 205, a default storage location, and/or user input received in step 225. At next step 235, the email is modified to include a link identifying the storage location where the attachment is stored. As described above, the link can also include other information about the attachment and/or other options associated with the link.

At next step 240, a copy of the modified email is sent to the email server. As described above, the email server, such as, for example, internal email server 20 of FIG. 1, can be configured to replace the original email and attachment with the modified email. At next step 245, the modified email is stored and the process returns to step 210.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for email attachment management, comprising:
receiving an email;
scanning the email to detect an attachment;
if the email contains an attachment, detaching the attachment from the email;
storing the detached attachment in a storage location on a storage medium;
modifying the email to include a link, the link at least identifying the storage location; and
storing the modified email.

2. The method as recited in claim 1, further comprising transmitting the modified email to an email server.

3. The method as recited in claim 1, further comprising transmitting the modified email to a mail user agent of a user.

4. The method as recited in claim 1, further comprising receiving user input from a user, the user input comprising at least user policies.

5. The method as recited in claim 4, further comprising storing the detached attachment in a storage location on a storage medium based on the user input.

6. The method as recited in claim 4, further comprising modifying the email based on the user input.

8. A computer program product for communication status management, the computer program product having a medium with a computer program embodied thereon, the computer program comprising:
computer program code for receiving an email;
computer program code for scanning the email to detect an attachment;
computer program code for detaching the attachment from the email;
computer program code for storing the detached attachment in a storage location on a storage medium;
computer program code for modifying the email to include a link, the link at least identifying the storage location; and
computer program code for storing the modified email.

9. The computer program product as recited in claim 8, further comprising computer program code for transmitting the modified email to an email server.

10. The computer program product as recited in claim 8, further comprising computer program code for transmitting the modified email to a mail user agent of a user.

11. The computer program product as recited in claim 8, further comprising computer program code for receiving user input from a user, the user input comprising at least user policies.

12. The computer program product as recited in claim 11, further comprising computer program code for storing the detached attachment in a storage location on a storage medium based on the user input.

13. The computer program product as recited in claim 11, further comprising computer program code for modifying the email based on the user input.

14. The computer program product as recited in claim 8, wherein the link includes a file name of the attachment.

15. The computer program product as recited in claim 8, wherein the link includes a description of the attachment.

16. The computer program product as recited in claim 8, wherein the link is configured to open the detached attachment.

17. A system for email attachment management, comprising:
an interface configured to receive user input from a user, the user input indicating at least a user policy;
a mail user agent coupled to the interface and configured to receive an email, the email including at least an attachment;
the mail user agent further configured to detach the attachment from the email, to store the attachment in a first storage location, to modify the email to generate a modified email, the modified email including at least a link, and to store the modified email in a second storage location; and
the link configured to identify the first storage location.

18. The system as recited in claim 17, wherein the mail user agent is further configured to store the email.

19. The system as recited in claim 17, wherein the mail user agent is further configured to transmit the modified email to an email server.

20. The system as recited in claim 17, further comprising an email server coupled to the mail user agent and configured to receive an email, the email including at least an attachment, to store the email in a third storage location, to transmit the email to the mail user agent, to receive a modified email from the mail user agent based on the email, and to replace the email with the modified email in the third storage location.
